(19) United States
(12) Patent Application Publication
(10) Pub. No.: US 2010/0005038 A1
(43) Pub. Date: Jan. 7, 2010

(54) SYSTEM AND METHOD FOR PERSONALIZED PRICE PER PRINT/COPY

(75) Inventors: RAMESH NAGARAJAN, PITTSFORD, NY (US); ROBERT NUUJA, ROCHESTER, NY (US)

Correspondence Address: Xerox Corporation (CDFS), 445 Broad Hollow Rd.-Suite 420, Melville, NY, 11747, US

(73) Assignee: XEROX CORPORATION, NORWALK, CT (US)

(21) Appl. No.: 12/166,874

(22) Filed: Jul. 2, 2008

(51) Int. Cl. G06Q 99/00

(52) U.S. Cl. 705/400

(57) ABSTRACT

A method of determining a quality output of a page based on a price input and examining content of a page. Examining content of a page includes detecting at least one object on the page and determining an approximate area of coverage of the at least one object on the page. The method also includes approximating a cost of printing the page based on the approximate area of coverage. The method also includes processing a user selected price for printing the page and comparing the user selected price to the approximated cost of printing the page. The method also includes generating the page based on the comparison between the user selected price and the approximated cost of printing the page.

### BACKGROUND

1. Technical Field

The present disclosure relates to billing for printing costs, and, in particular, to a system and method for determining a quality output of a page based on a price input.

2. Description of Related Art

Modem color printing systems mark a substrate with patterns of lines or small dots of oval or round shape onto the printing substrate (e.g., such as paper). The color printing system can mark the printing substrate with multiple colors of ink or toner called colorants. Although most color printing systems have only four primary colors of toner (or ink), a much wider variety of colors are available for color perception because of physiological and psychophysical aspects of human color vision.

The colors of toner (or ink) chosen to create the wider variety of perceived colors is generally referred to as the color gamut. The most typically used color gamut is the “CMYK” color gamut. The “C” refers to Cyan toner, the “M” refers to “Magenta” toner, the “Y” refers to the “Yellow” toner, and the “K” refers to the “Black” toner. Although there are three types of color receptors in the human eye (and one additional type of receptor for night vision), four toner colors are generally used because black toners are relatively cheaper and when used to produce black, a combination of CMY without K is more prone to color plane registration error and/of may not produce as dark a black (e.g., printing systems typically use CMYK to produce a dark and rich black in photographic images). Further, it is more efficient to use a black toner than to combine the cyan, magenta, and yellow toners to make a black color, e.g.; a black toner dries faster than when combing the three aforementioned toners to make a black marking on a substrate. The cost of the toner (or ink) should be taken into consideration when printing color and/or monochrome pages.

However, the cost of the toner is generally only about 20% to 30% of the total cost per printing substrate (e.g., a page can be printed on a substrate) that is incurred when using a printing system. One business model employed by manufacturers of printing systems is to lease (becoming the “lessor”) a printing system to the end user and charge a monthly “use” fee and a “service” fee. The “use” fee is generally fixed; however, the “service” fee includes estimated fixed and variable costs, and a profit margin. Some of the estimated costs that are included in the service fee are toner usage costs, technician costs, repair costs, IT infrastructure costs, field offices costs, managers' and engineers' salaries, parts costs, labor costs, and the like (generally the end user pays for the printing substrate, e.g., paper, however, some end users may contract otherwise).

If the agreed upon fee structure is not properly calculated, the actual costs may exceed expectations reducing the profit margin (possibly causing the lessor to incur a loss). Additionally, an improperly calculated service fee can cause a particular end user to pay more than their proportionate service usage. Thus, miscalculated service costs increase market inefficiencies into the printing system's market. To mitigate the risk of loss to a lessor and to provide the lessee (i.e., end user) with a proportionate service fee, the service cost generally includes a “per click” fee. This fee can facilitate efficient allocation of the resources of both parties.

This “per click” fee is an additional fee that is applied to each particular piece of printed page. The per click fee includes an estimated toner cost, a risk premium cost, and a profit margin. The risk premium cost is an estimated service cost that a particular piece of printing substrate will probabilistically cause the lessor to incur a service expense. Printing a color page has a higher probability of incurring additional service costs as compared to printing a monochrome page.

One approach is to charge a “per click” fee of a fixed amount when an end user prints a page that is purely monochrome, and to charge a different amount for the “per click” fee when printing a color page. This is referred to as the “one size fits all billing approach” and is simply billing one fee for printed monochrome pages and another fee for printed color pages, regardless of the content in the printed page. For example, the “per click” fee may be $0.01 (U.S) per monochrome printed page and $0.08 (U.S.) per color printed page.

The “one size fits all billing approach” does not generally take into account the objects that are in the page. For example, there are several types of monochrome and/or color objects that can be printed onto a substrate. Some of the types of objects that may be printed are: monochrome contone objects, color contone objects, monochrome text objects, color text objects, monochrome line art objects, color line art objects, monochrome graphic objects, color graphic objects, monochrome low frequency halftone objects, color low frequency halftone objects, monochrome high frequency halftone objects, color high frequency halftone objects, monochrome solid fill objects, and color solid fill objects.

In one exemplary prior art method, an approximation of the service cost associated with a particular printed page is made by applying a cost function that uses the aggregate toner area of coverage of the printed page, the printing medium substrate dimensions, and the finishing options applied. The aggregate toner area of coverage may be approximated by counting the aggregate number of color pixels (e.g., counting the number of the CMYK pixels within an object).

The prior art method does not take into account how the color pixels are distributed in a page (e.g., how the pixels are distributed and/or clustered), the kinds of objects in the page the pixels are used to form, and the pixel density.

### SUMMARY

According to one embodiment of the present disclosure, a method of determining a quality output of a page based on a price input includes examining content of a page. Examining content of a page includes detecting at least one object on the page and determining an approximate area of coverage of the at least one object on the page. The method also includes approximating a cost of printing the page based on the approximate area of coverage. The method also includes processing a user selected price for printing the page and comparing the user selected price to the approximated cost of printing the page. The method also includes generating the page based on the comparison between the user selected price and the approximated cost of printing the page.

According to another embodiment of the present disclosure, a method of determining a quality output of a page based on a price input includes examining content of a page. Examining content of a page includes detecting at least one object on the page and determining an approximate area of coverage of the at least one object on the page. The method also includes approximating a cost of printing the page based on the approximate area of coverage. The method also includes processing a user selected price for printing the page and comparing the user selected price to the approximated cost of printing the page. The method also includes adjusting at least one quality parameter of the page if the approximated cost of printing the page is not less than the user selected price.

### BRIEF DESCRIPTION OF THE DRAWINGS

These and other advantages will become more apparent from the following detailed description of the various embodiments of the present disclosure with reference to the drawings wherein:

FIGS. 1A and 1B are graphic representations of pages with objects on the pages in accordance with the present disclosure.

FIG. 2 is a user interface in accordance with embodiments of the present disclosure; and

FIG. 3 is a block diagram illustrating a method for altering the quality of a page based on a user selected price.

### DETAILED DESCRIPTION

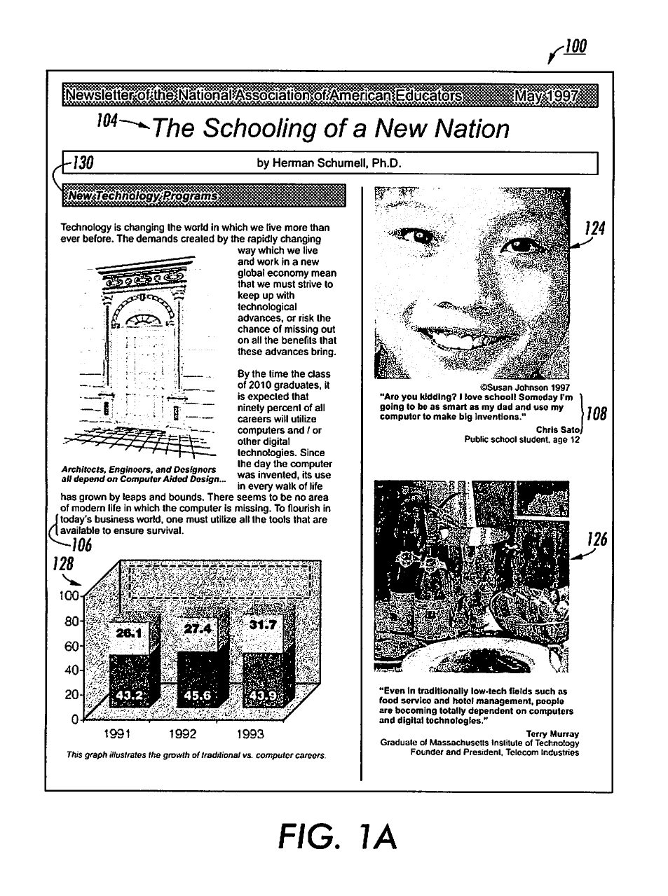

FIGS. 1A and 1B show pages 100 and 102, respectively. Page 100 includes color text objects 104, 106, 108, color high frequency halftone objects 124 and 126, color graphic object 128, and color line art object 130. Page 102 includes color text objects 110, 1 12, 114, 116, 118, 120, and 122. The types of objects that may be included in a page are: monochrome contone objects, color contone objects, monochrome text objects, color text objects, monochrome line art objects, color line art objects, monochrome graphic objects, color graphic objects, monochrome low frequency halftone objects, color low frequency halftone objects, monochrome high frequency halftone objects, color high frequency halftone objects, monochrome solid fill objects, and/or color solid fill objects.

A page can take many forms, e.g., pages 100 and 102. A page is simply what is to be marked onto the printing substrate. Two pages may be marked on both sides of the substrate to form a double-sided substrate (e.g., sheet of paper). A page may be a scanned page, an image of a page, a page description language page, a printed page, a copied page, a computer-memory based page, a hard-drive based page, a raster page, a vector graphics page, or the like. Additionally or alternatively, pages 100 and 102 may be a representation of a page in printed form (e.g., printed pages).

One prior art system has only two mutually exclusive modes for printing page content. The prior art system either prints a color page in “full color” or in “monochrome only”. In the full color mode, all of the color objects in the page are printed in color. In the monochrome only mode, all of the color objects are converted to monochrome objects before (or simultaneously with) marking the page on a substrate (e.g., printing a page on a sheet of paper).

These two methods of the prior art system may be used in conjunction with any printing technology, including a computer printing system, a copying machine, a xerographic system, an electrostatographic system, a printing system, a photocopying system, or the like. Referring to FIGS. 1A and 1B, pages 100 and 102 may be printed using the prior art system. However, many entities involved in the color printing industry bill the costs of printing a page based on which mode (i.e., full color or monochrome only) is utilized to print the page regardless of the content of the page (e.g., types of objects on the page). By way of example, using the prior art system pages 100 and 102 are billed at the same rate when printed using the full color mode despite page 100 including significantly more complex color objects relative to page 102.

Because of the significant price difference between printing pages using the full color mode versus using the monochrome only mode, many system administrators of shared printing resources prevent users from printing in color or restrict their use. As mentioned above, printing color pages generally has an increased service cost as compared to printing monochrome pages. However, different types of color objects have different effects on the aggregate service cost. For example, printing a page having color text with the remainder of the page being in monochrome does not generally incur additional service costs as compared to printing a page in monochrome only. Additionally, color text objects do not use as much toner as compared to color graphic objects, and color high or low frequency halftone objects. Additionally, printing a color object with fewer than all of the colorants available is also cheaper than printing the object in full color, e.g., it is cheaper to print a color object with only 2 out of 4 colorants of the color gamut than printing the object with all 4 colorants.

With continued reference to FIGS. 1A and 1B, the approximate area of coverage of the color objects in page 100 is larger relative to the approximate area of coverage of the color objects in page 102. The “area of coverage” of an object may be the number of pixels of the object and/or the area of the object. To determine the approximate area of coverage of an object, the number of pixels of that object may be counted during so-called “ripping” of the page and/or through use of an auto-windowing technique. An auto-windowing technique is described in commonly owned U.S. Pat. No. 5,850,474 and U.S. Pat. No. 6,240,205, the entire contents of both of which are incorporated herein by reference.

In one prior art method, pages 100 and 102 would be billed a “per click” fee that is based upon the determined approximate area of coverage of the color objects of pages 100 and 102, respectively, resulting in the two pages being billed at about the same fee when printed, or at exactly the same fee. However, what the prior art method fails to account for is the correlation of the service cost associated with a particular printed page to the page content (e.g., the objects in the page). For example, a 1×1 inch object when printed on a page may have higher service cost if the object were a color high frequency halftone object as compared to a color low frequency halftone object or a color line art object. The reasons for the additional service costs may be partially due to the fact that smaller halftone cluster dots make slight color separation misregistrations more objectionable to the human eye as compared to simple color line arts.

A method of billing for printing service that accounts for printing service costs is disclosed in commonly assigned U.S. patent application Ser. No. 11/873113 entitled “System and Method of Billing for Printing Service Costs by Examining the Content of a Page”, the entire contents of which are incorporated herein by reference. The method of billing for printing service that accounts for printing service costs may be implemented using software executable instructions. More specifically, the method may be executed through use of a suitable processing module (not explicitly shown) in operative communication with the printing device (not explicitly shown) printing a print job or a copying job. The processing module may include a memory configured to store software instructions and a processor configured to execute the software instructions stored in memory.

Monochrome and/or color objects (e.g., monochrome contone objects, color contone objects, monochrome text objects, color text objects, etc.) are detected on a page by examining each page of the print job. The area of coverage is determined based on the one or more objects detected on each page of the print job. As mentioned hereinabove, the approximate area of coverage for a detected object may be determined by counting the number of pixels for that detected object during, for example, ripping of the page and/or while segmenting the image using a method like auto-windowing. After an object is detected and the approximate area of coverage of the detected object is determined, the approximate area of coverage is applied to a cost function to approximate the service cost or the so-called “true cost” of printing the page. Various cost functions are described in commonly assigned U.S. patent application Ser. No. 11/873113, the entire contents of which having been previously incorporated by reference herein, for use with the method described above to approximate the service cost or true cost of printing a page.

Using the above described method, customers are provided printing options that allow color documents to be printed at a lower price. For example, a print mode may be offered (e.g., via a user interface) to provide the user with the option of printing text and line art in color with the remainder of the content (e.g., color graphic objects) printed in black and white. This provides the user with a customizable billing option for printing services.

The present disclosure provides users with additional customizable billing options for printing services to satisfy varying user demands. More specifically, the present disclosure provides a method of determining a quality output of a page based on a price input. That is, a price per page that the user is willing to pay for a color output of a print job or copy job may be selected by the user as an input (e.g., via a user interface) and the quality of the page is an output based on the user selected price.

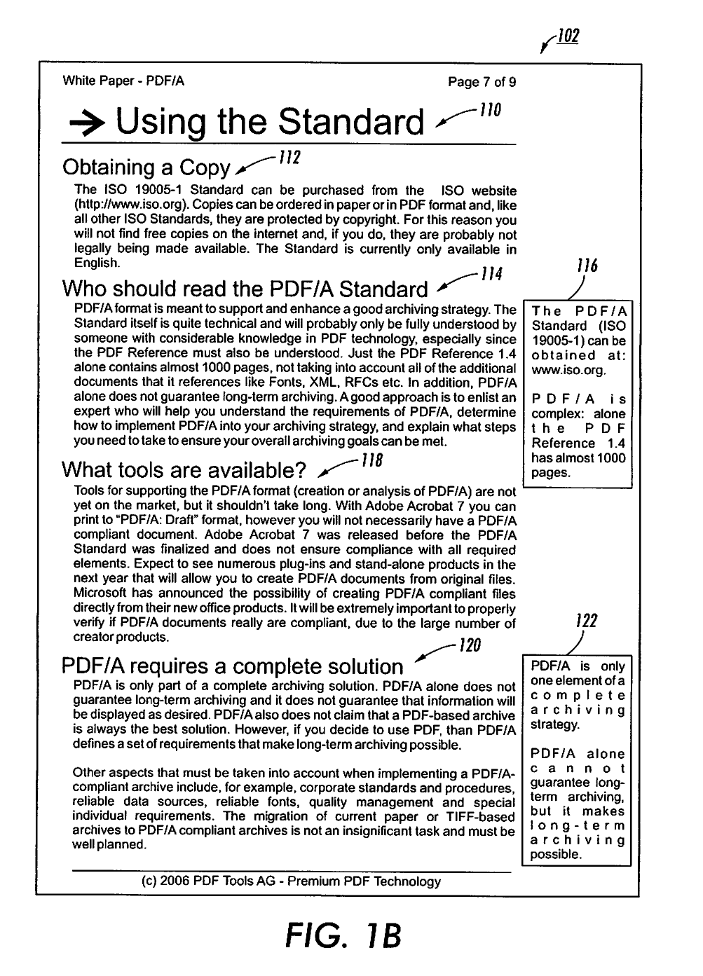

Referring to FIG. 2, a user interface 200 is shown for use with the present disclosure. The user interface 200 may be implemented using any suitable processing and/or computing device and graphically displayed via a display (e.g., touch-screen and/or LCD, etc.) onboard one or more printing devices (not explicitly shown) and/or in operative communication therewith. Additionally or alternatively, the user interface 200 may be implemented utilizing a print driver onboard the printing device. Generally, the user interface 200 includes a price selection interface 210, a main interface 220, and a display interface 230.

The price selection interface 210 provides the user with a plurality of pricing options from which to select, including a minimum and maximum price. The minimum price (e.g., U.S. $0.01) may be selected to generate a page in black and white only (e.g., devoid of color) and the maximum price (e.g., U.S. $0.09) may be selected to generate a page in full color. Further, a default price (e.g., $0.05) may be selected to generate a page with predetermined quality parameters (e.g., saturation, brightness, contrast, background suppression, etc.). The price selection interface 210 may include a plurality of prices (e.g., U.S. $0.03, U.S. $0.07, etc.) ranging between the minimum and maximum prices to provide the customer with various options for altering the quality parameters of a page. A page may be a print job, a copy job, and/or one of multiple pages of either a print job or copy job. Quality parameters of a printed or copied page may be, for example, saturation, brightness, contrast, tint, color, background suppression, etc. Other quality parameters may be included and the above list should not be construed as exhaustive. The pricing options depicted in FIG. 2 are illustrative only and other price designations are contemplated. For example, the price range may be customizable according to the market region in which the method of the present disclosure is being implemented.

Once a price is selected by the user via the price selection interface 210, the display interface 230 displays an image of the page having quality parameters in accordance with the price selected by the user. In the illustrated embodiment, the display interface 230 displays a first image of the page having the default quality parameters and a second image of the page having the quality parameters based on the price selected by the user. In this manner, the user may view the difference between image quality and, thus, vary the price selection accordingly. Further, the user interface 200 may display a suitable message (e.g., text, graphical, etc.) to warn the user of the potential loss of quality based on the price selected.

The main interface 220 is configured to permit the user to finalize a price selection (e.g., via a “save” link), undo or deselect a price selection (e.g., via an “undo” link), and/or cancel out of the user interface (e.g., via a “cancel” link) to access other interfaces of a printing device. The main interface 220 may also include user login information (e.g., username) to identify the user to be billed for the print or copy job.

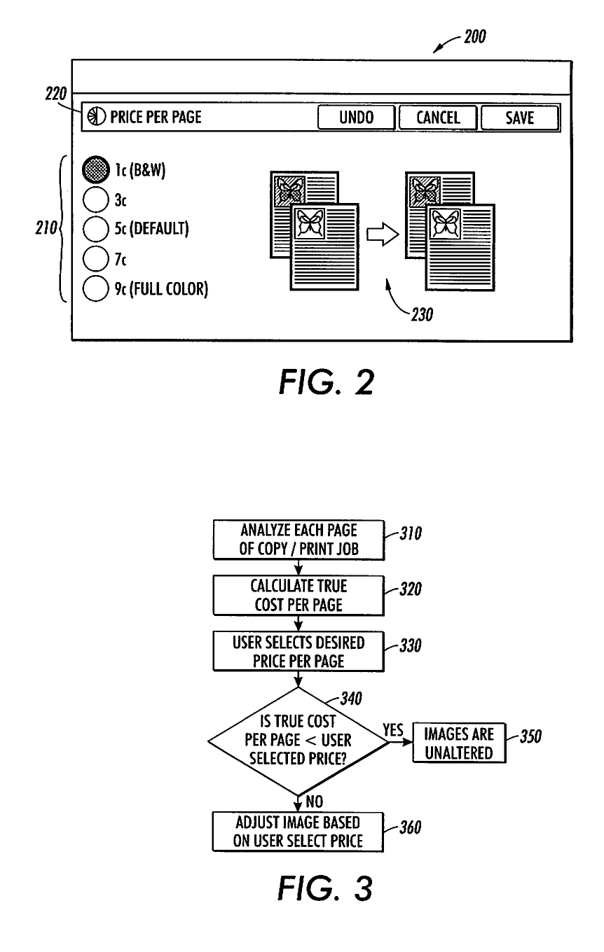

FIG. 3 is a flow chart diagram illustrating a method of providing printing service based on a user-selected price. The method may be implemented using software executable instructions. More specifically, the method may be executed through use of a suitable processing module (not explicitly shown) in operative communication with the printing device that is generating the print job. The processing module may include a memory configured to store software instructions and a processor configured to execute the software instructions stored in the memory. In step 310, the content of the page is analyzed. More specifically, one or more objects on the page are detected and the approximate area of coverage of the detected object(s) is determined. Based on the determined approximate area of coverage, the service cost or true cost of the page is determined in step 320 utilizing one of the cost functions discussed hereinabove. In step 330, the user, through use of the price selection interface 210, selects the desired price per page. The user has the option to undo or deselect price options via the main interface 220 and subsequently reselect a price option via the price selection interface 210. That is, step 330 may be repeated in accordance with the users interaction with the price selection interface 210. Once the user commits to a price per page and subsequently opts to finalize the price selection (e.g., via the “save” link of the main interface 220), in step 340, the selected price is processed (e.g., via the processing module) and compared to the true cost of the page determined in step 320. If the true cost of the page is less than the price selected by the user, the quality parameters of the page are unaltered in step 350. In this manner, if the user is willing to pay more per page than the true cost per page, the administrator and/or owner of the printing device retain the realized profit. If the true cost per page is not less than the price selected by the user, the quality parameters of the page are altered in accordance with the selected price in step 360. In this scenario, the quality parameters of the page are altered such that the true cost per page will be at most equivalent to, but not more than, the price selected by the user. That is, the administrator of the printing device does not realize a profit from the page, however, the administrator does not incur a loss from the page either.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of determining a quality output of a page based on a price input, comprising:
examining content of a page comprising:
detecting at least one object on the page; and
determining an approximate area of coverage of the at least one object on the page;
approximating a cost of printing the page based on the approximate area of coverage;
processing a user selected price for printing the page;
comparing the user selected price to the approximated cost of printing the page; and
generating the page based on the comparison between the user selected price and the approximated cost of printing the page.

2. The method according to claim 1, further comprising adjusting at least one quality parameter of the page based on the comparison between the user selected price and the approximated cost of printing the page.

3. The method according to claim 2, wherein the at least on e quality parameter is selected from the group consisting of saturation, brightness, contrast, background suppression, color, and tint.

4. The method according to claim 1, further comprising maintaining the quality of the page based on the comparison between the user selected price and the approximated cost of printing the page.

5. The method according to claim 1, wherein the user selected price is one of a minimum price, a maximum price, and a default price.

6. The method according to claim 5, wherein the page of the generating step is generated in black and white only if the user selected price is the minimum price.

7. The method according to claim 5, wherein the page of the generating step is generated in full color if the user selected price is the maximum price.

8. The method according to claim 1, wherein the at least one object on the page includes at least one of a monochrome contone object, a color contone object, a monochrome text object, a color text object, a monochrome line art object, a color line art object, a monochrome graphic object, a color graphic object, a monochrome low frequency halftone object, a color low frequency halftone object, a monochrome high frequency halftone object, a color high frequency halftone object, a monochrome solid fill object, and a color solid fill object.

9. The method according to claim 1, wherein the detecting step further includes at least one of detecting at least one color object and detecting at least one monochrome object.

10. The method according to claim 9, wherein the step of detecting at least one color object comprises at least one of:
detecting at least one color contone object;
detecting at least one color text object;
detecting at least one color line art object;
detecting at least one color graphic object;
detecting at least one color low frequency halftone object;
detecting at least one color high frequency halftone object; and
detecting at least one color solid fill object.

11. The method according to claim 1, wherein the step of determining the approximate area of coverage of the at least one detected object on the page further comprises counting a number of pixels of the at least one detected object.

12. The method according to claim 11, wherein the step of counting the number of the pixels of the at least one detected object occurs during at least one of a ripping of the page and an implementation of an auto-windowing technique on the page.

13. The method according to claim 1, wherein the page is one of a scanned page, an image of a page, a page description language page, a printed page, a copied page, a computer-memory based page, a hard-drive based page, a raster page, and a vector graphics page.

14. The method according to claim 1, wherein the method is implemented by an operative set of processor executable instructions configured for execution by at least one processor.

15. The method according to claim 14, wherein the method is implemented through a user interface in operative communication with at least one printing device.

16. The method according to claim 15 wherein the page of the generating step is generated graphically via the user interface.

17. A method of determining a quality output of a page based on a price input, comprising:
examining content of a page comprising:
detecting at least one object on the page; and
determining an approximate area of coverage of the at least one object on the page;
approximating a cost of printing the page based on the approximate area of coverage;
processing a user selected price for printing the page;
comparing the user selected price to the approximated cost of printing the page; and
adjusting at least one quality parameter of the page if the approximated cost of printing the page is not less than the user selected price.

18. The method according to claim 17, wherein the at least one quality parameter is selected from the group consisting of saturation, brightness, contrast, background suppression, color, and tint.

19. The method according to claim 17, further comprising maintaining the quality of the page if the approximated cost of printing the page is less than the user selected price.

20. The method according to claim 17, wherein the page is one of a print job and a copy job.
